(19) United States
(12) Patent Application Publication
(10) Pub. No.: US 2019/0007747 A1
(43) Pub. Date: Jan. 3, 2019

(54) TECHNOLOGIES FOR PROVIDING ADAPTIVE PLATFORM QUALITY OF SERVICE

(71) Applicant: Intel Corporation, Santa Clara, CA (US)

(72) Inventors: Francesc Guim Bernat, Barcelona (ES); Susanne M. Balle, Hudson, NH (US); Andrew J. Herdrich, Hillsboro, OR (US); Karthik Kumar, Chandler, AZ (US); Rahul Khanna, Portland, OR (US)

(21) Appl. No.: 15/636,779

(22) Filed: Jun. 29, 2017

(51) Int. Cl. H04N 21/647; H04L 29/08

(52) U.S. Cl. CPC H04N 21/64738; H04L 29/08954

(57) ABSTRACT

Technologies for providing adaptive platform quality of service include a compute device. The compute device is to obtain class of service data for an application to be executed, execute the application, determine, as a function of one or more resource utilizations of the application as the application is executed, a present phase of the application, set a present class of service for the application as a function of the determined phase, wherein the present class of service is within a range associated with the determined phase, determine whether a present performance metric of the application satisfies a target performance metric, and increment, in response to a determination that the present performance metric does not satisfy the target performance metric, the present class of service to a higher class of service in the range. Other embodiments are also described and claimed.

### BACKGROUND

Typical platform quality of service (pQoS) features of a compute device enable an administrator or user of the compute device to reserve, to an application, access to certain resources that are primarily responsible for affecting the performance of the application. For example, if the performance of the application is particularly affected by the availability of data in the low level cache (LLC), a user may utilize a pQoS feature of the compute device to reserve a number of ways in the LLC to reduce the likelihood that cache lines containing frequently used data by the application are not evicted from the LLC. As a result, the performance of the application is less affected by other concurrently executing applications that heavily use the LLC of the compute device. However, the reservation of the resources (e.g., the ways in the LLC) remains in place regardless of whether the application is actually making use of all of the reserved resources at any given time, potentially to the detriment of concurrently executing applications that would otherwise utilize the resources.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for providing adaptive platform quality of service;

FIG. 2 is a simplified block diagram of at least one embodiment of a compute device of the system of FIG. 2;

FIG. 3 is a simplified block diagram of at least one embodiment of an environment that may be established by a compute device of FIGS. 1 and 2; and

FIGS. 4-7 are a simplified block diagram of at least one embodiment of a method for adaptively controlling a platform quality of service that may be performed by a compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

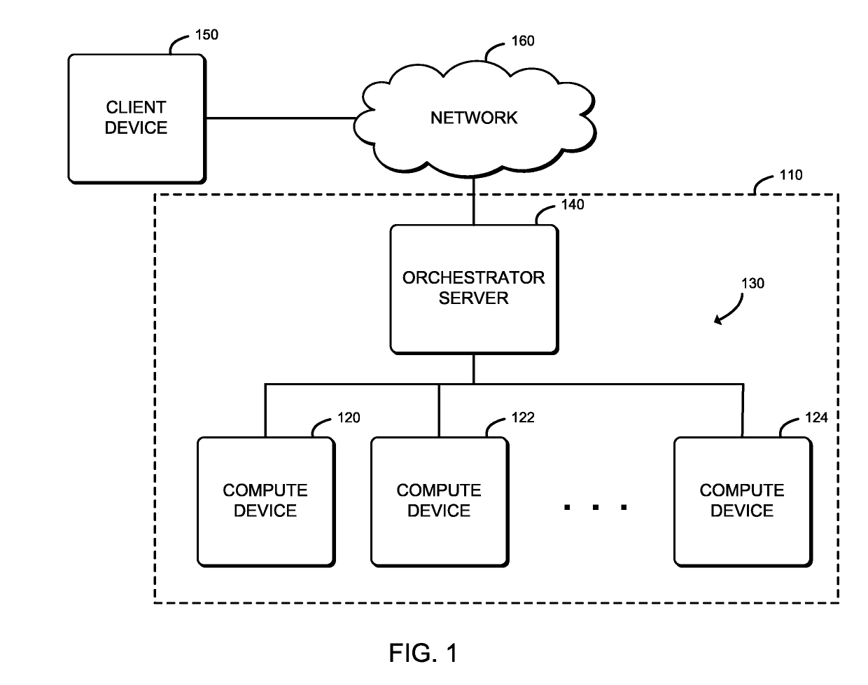

As shown in FIG. 1, an illustrative system 110 for providing adaptive platform quality of service (pQoS) includes a set of compute devices 130 in communication with an orchestrator server 140. The set includes compute devices 120, 122, and 124. While three compute devices 130 are shown, it should be understood that in other embodiments, the set may include a different number of compute devices 130. In operation, each compute device 130 executes one or more applications assigned to it. The applications may be assigned by the orchestrator server 140, such as in response to a request for services from a client device 150 in communication with the orchestrator server 140 through a network 160, or from another source. In the illustrative embodiment, each compute device 130 obtains class of service data, which may be embodied as any data indicative of an amount of one or more resources (e.g., a number of ways of cache associativity, memory bandwidth, etc.) to be allocated to each application for each class of service in a range of classes of service, a target performance metric for each phase of each application, and a maximum class of service for each phase of each application. In the illustrative embodiment, a class of service refers to a degree to which resources of the compute device 130 are reserved for use by a given application (e.g., to a core of the compute device 130 executing the application) to improve latency, throughput, and/or other characteristics associated with the performance of the application.

Further, in the illustrative embodiment, each phase of an application may be embodied as a set of operations that exhibit a particular utilization of resources (e.g., a relatively low processor utilization and a relatively high memory utilization, a relatively high processor utilization and a relatively low memory utilization, etc.). In operation, each compute device 130 determines which phase a particular application is in as the compute device 130 executes the application, determines whether the performance of the application satisfies a target performance metric associated with the present phase of the application, and if not, increases the class of service to a higher class of service within the range of classes of service associated with the present phase. Conversely, if the performance of the application satisfies the target performance metric, the compute device 130, in the illustrative embodiment, iteratively decreases the class of service until the target performance metric can no longer be satisfied (e.g., to find the minimum class of service to needed to satisfy the target performance metric). As such, the compute device 130 adaptively releases resources for use by other applications executed concurrently on the compute device 130 (e.g., by other cores in the compute device 130), enabling those applications to improve their performance without adversely impacting the ability of the present application to satisfy the target performance metric for the present phase.

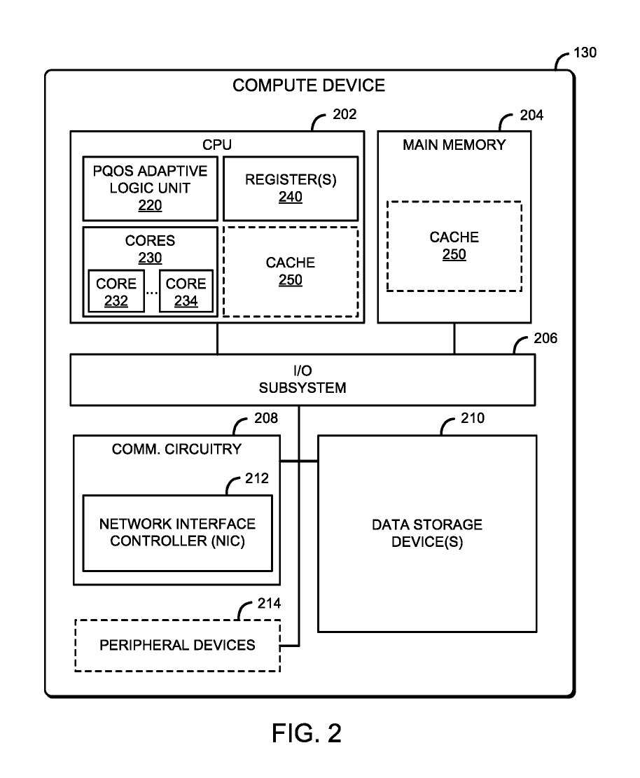

Referring now to FIG. 2, each compute device 130 may be embodied as any type of device capable of performing the functions described herein. For example, in some embodiments, each compute device 130 may be embodied as, without limitation, a rack-mounted computer, a distributed computing system, a server computer, a desktop computer, a workstation, a laptop computer, a notebook computer, a tablet computer, a smartphone, a multiprocessor system, a consumer electronic device, a smart appliance, and/or any other device capable of obtaining class of service data for an application to be executed, executing the application, determining, as a function of one or more resource utilizations of the application as the application is executed, a present phase of the application, setting a present class of service for the application as a function of the determined phase, determining whether a present performance metric of the application satisfies the target performance metric, and adjusting the class of service within the range to satisfy the target performance metric while enabling other applications to utilize resources that are not needed to satisfy the target performance metric. As shown in FIG. 2, the illustrative compute device 130 includes a central processing unit (CPU) 202, a main memory 204, an input/output (I/O) subsystem 206, communication circuitry 208, and one or more data storage devices 210. Of course, in other embodiments, the compute device 130 may include other or additional components, such as those commonly found in a computer (e.g., peripheral devices, a display, etc.). Additionally, in some embodiments, one or more of the illustrative components may be incorporated in, or otherwise form a portion of, another component. For example, in some embodiments, the main memory 204, or portions thereof, may be incorporated in the CPU 202.

The CPU 202 may be embodied as any type of processor or processors capable of performing the functions described herein. As such, the CPU 202 may be embodied as a single or multi-core processor(s), a microcontroller, or other processor or processing/controlling circuit. In some embodiments, the CPU 202 may be embodied as, include, or be coupled to a field programmable gate array (FPGA), an application specific integrated circuit (ASIC), reconfigurable hardware or hardware circuitry, or other specialized hardware to facilitate performance of the functions described herein. In the illustrative embodiment, the CPU 202 includes a platform quality of service (pQoS) logic unit 220, which may be embodied as any device or circuitry capable of determining the present phase of each application executed by the compute device 130, determining a range of classes of service associated with each phase, and selectively assigning classes of service within the determined ranges to the applications to provide sufficient resources to the applications to satisfy target performance metrics without reserving excess resources that could be used by other applications.

In the illustrative embodiment, the CPU 202 includes multiple cores 230 which may be embodied as any devices capable of separately executing applications and utilizing other resources of the compute device (e.g., portions of a low level cache (LLC) 250, main memory 204, bandwidth of the I/O subsystem 206, bandwidth of the communication circuitry 208, etc.) in the execution of the applications. In the embodiment illustrated in FIG. 2, two cores 232, 234 are shown. However, it should be understood that the number of cores 230 may differ in other embodiments. Additionally, in the illustrative embodiment, the CPU 202 includes one or more registers 240, such as model-specific registers (MSRs). As described in more detail herein, each register 240 may be embodied as any device or circuitry capable of storing a value that may be accessed (read and/or written to) by the compute device 130. In the illustrative embodiment, one or more of the registers 240 may indicate the present classes of service for resources used by a particular application. Additionally, in the illustrative embodiment, the CPU 202 includes the cache 250 which may be embodied as any device or circuitry capable of temporarily storing copies of data from frequently used locations of the main memory 204 and providing the cores 230 with relatively faster access (i.e., as compared to the main memory 204) to the data.

The main memory 204 may be embodied as any type of volatile (e.g., dynamic random access memory (DRAM), etc.) or non-volatile memory or data storage capable of performing the functions described herein. In some embodiments, all or a portion of the main memory 204 may be integrated into the CPU 202. In operation, the main memory 204 may store various software and data used during operation such as data utilized by the applications executed by the cores 230, telemetry data, phase data, class of service data, operating systems, applications, programs, libraries, and drivers. The main memory 204, in some embodiments, may also include the cache 250 described above.

The I/O subsystem 206 may be embodied as circuitry and/or components to facilitate input/output operations with the CPU 202, the main memory 204, and other components of the compute device 130. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with one or more of the CPU 202, the main memory 204, and other components of the compute device 130, on a single integrated circuit chip.

The communication circuitry 208 may be embodied as any communication circuit, device, or collection thereof, capable of enabling communications over the network 160 between the compute device 130 and another device (e.g., the orchestrator server 140 and/or another compute device 130). The communication circuitry 208 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 208 includes a network interface controller (NIC) 212, which may also be referred to as a host fabric interface (HFI). The communication circuitry 208 may be located on silicon separate from the CPU 202, or the communication circuitry 208 may be included in a multi-chip package with the CPU 202, or even on the same die as the CPU 202. The NIC 212 may be embodied as one or more add-in-boards, daughtercards, network interface cards, controller chips, chipsets, specialized components such as a field programmable gate array (FPGA) or application specific integrated circuit (ASIC), or other devices that may be used by the compute device 130 to connect with another device (e.g., the orchestrator server 140 and/or another compute device 130). In some embodiments, NIC 212 may be embodied as part of a system-on-a-chip (SoC) that includes one or more processors, or included on a multichip package that also contains one or more processors. In some embodiments, the NIC 212 may include a local processor (not shown) and/or a local memory (not shown) that are both local to the NIC 212. In such embodiments, the local processor of the NIC 212 may be capable of performing one or more of the functions of the CPU 202 described herein. Additionally or alternatively, in such embodiments, the local memory of the NIC 212 may be integrated into one or more components of the compute device 130 at the board level, socket level, chip level, and/or other levels.

The one or more illustrative data storage devices 210, may be embodied as any type of devices configured for short-term or long-term storage of data such as, for example, memory devices and circuits, memory cards, hard disk drives, solid-state drives, or other data storage devices. Each data storage device 210 may include a system partition that stores data and firmware code for the data storage device 210. Each data storage device 210 may also include an operating system partition that stores data files and executables for an operating system.

Additionally or alternatively, the compute device 130 may include one or more peripheral devices 214. Such peripheral devices 214 may include any type of peripheral device commonly found in a compute device such as a display, speakers, a mouse, a keyboard, and/or other input/output devices, interface devices, and/or other peripheral devices.

The orchestrator server 140 and the client device 150 may have components similar to those described in FIG. 2. As such, the description of those components of the compute device 130 is equally applicable to the description of components of the orchestrator server 140 and the client device 150 and is not repeated herein for clarity of the description, with the exception that, in the illustrative embodiment, the orchestrator server 140 and the client device 150 may not include the pQoS adaptive logic unit 220. It should be appreciated that any of the orchestrator server 140 and the client device 150 may include other components, sub-components, and devices commonly found in a computing device, which are not discussed above in reference to the compute device 130 and not discussed herein for clarity of the description.

As described above, the compute devices 130, the orchestrator server 140, and the client device 150 are illustratively in communication via the network 160, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

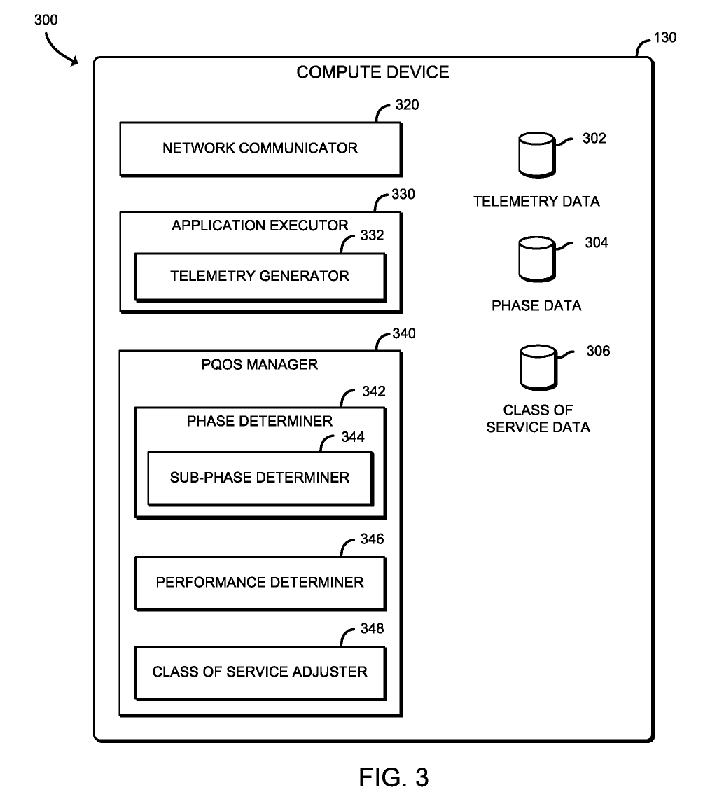

Referring now to FIG. 3, in the illustrative embodiment, each compute device 130 may establish an environment 300 during operation. The illustrative environment 300 includes a network communicator 320, an application executor 330, and a platform quality of service manager 340. Each of the components of the environment 300 may be embodied as hardware, firmware, software, or a combination thereof. As such, in some embodiments, one or more of the components of the environment 300 may be embodied as circuitry or a collection of electrical devices (e.g., network communicator circuitry 320, application executor circuitry 330, platform quality of service manager circuitry 340, etc.). It should be appreciated that, in such embodiments, one or more of the network communicator circuitry 320, application executor circuitry 330, or platform quality of service manager circuitry 340 may form a portion of one or more of the CPU 202, the main memory 204, the I/O subsystem 206, and/or other components of the compute device 130.

In the illustrative embodiment, the environment 300 includes telemetry data 302 which may be embodied as any data indicative of the utilizations of resources (e.g., relative values, such as percentages, of available resources utilized by each application, or actual values indicative of the amount of each resource used by each application), which may be determined continually (e.g., at predefined intervals) by the compute device 130. Additionally, the telemetry data 302 indicates the performance of the applications, such as instructions per cycle executed by the core 230 associated with each application, and/or other measures of the quality of service associated with each application. Additionally, the illustrative environment 300 includes phase data 304 which may be embodied as any data indicative of application phases and the lengths of time of those phases (i.e., phase residencies), for each of the applications. Further, the illustrative environment 300 includes class of service data 306 which may be embodied as any data indicative of an amount of one or more resources to be allocated to an application for each class of service in a range of classes of service, a target performance metric for each phase of the application, and a maximum class of service for each phase of the application. Additionally, the class of service data 306 may indicate a frequency at which to measure the performance of an application, and an indication of the rate (e.g., linearly, exponentially, etc.) at which the class of service should be incremented for a given phase of an application in response to a determination that the application is not satisfying the target performance metric with the resources allocated at the present class of service.

In the illustrative environment 300, the network communicator 320, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the compute device 130, respectively. To do so, the network communicator 320 is configured to receive and process data packets and to prepare and send data packets to a system or compute device (e.g., the orchestrator server 140). Accordingly, in some embodiments, at least a portion of the functionality of the network communicator 320 may be performed by the communication circuitry 208, and, in the illustrative embodiment, by the NIC 212.

The application executor 330, which may be embodied as hardware, firmware, software, virtualized hardware, emulated architecture, and/or a combination thereof as discussed above, is configured to execute applications assigned to the compute device 130 and generate telemetry data in the process, for use by the platform quality of service manager 340. To do so, in the illustrative embodiment, the application executor 330 includes a telemetry generator 332 which, in the illustrative embodiment, is configured to receive data from components of the compute device 130, including the cores 230, and other components such as the memory 204, the I/O subsystem 206, the communication circuitry 208, and/or the data storage devices 210, and parse and store the data as the telemetry data 302 in association with identifiers of the respective components and of the applications that the components were performing operations on behalf of when the data was generated. In the illustrative embodiment, the telemetry generator 332 may actively poll each of the components (e.g., the cores 230, the memory 204, the I/O subsystem 206, the communication circuitry 208, the data storage devices 210, etc.) available within the compute device 130 for updated telemetry data 302 on an ongoing basis or may passively receive the telemetry data 302 from the components, such as by monitoring one or more registers, etc.

The platform quality of service manager 340, which may be embodied as hardware, firmware, software, virtualized hardware, emulated architecture, and/or a combination thereof, is configured to obtain the class of service data 306, analyze the telemetry data 302 to determine the present phase of each application executed by the cores 230, determine whether the present performance of each application satisfies the corresponding target performance metric indicated in the class of service data 306 for the present phase of each application, and selectively adjust (e.g., incrementally increase or decrease) the class of service associated with one or more of the applications to satisfy the corresponding target performance metric without committing resources to the application beyond the amount needed to satisfy the target performance metric. To do so, in the illustrative embodiment, the platform quality of service manager 340 includes a phase determiner 342, a performance determiner 346, and a class of service adjuster 348.

The phase determiner 342, in the illustrative embodiment, is configured to compare the telemetry data 302 associated with each application to reference resource utilization characteristics associated with known phases of each application (e.g., reference phases in the phase data 304). For example, if one phase of an application is characterized by a period of high CPU utilization (e.g., a percentage above a threshold percentage) and low memory utilization (e.g., a percentage below a threshold percentage), and the telemetry data 302 associated with the application indicates high CPU utilization and low memory utilization, the phase determiner 342 may determine that the application is in the phase described above, as distinguished from another phase in which the resource utilizations differ. The phase determiner 342 may additionally include a sub-phase determiner 344, which may be configured to detect sub-phases within a phase. A sub-phase may be embodied as relatively short period of time in which variations in the utilizations of one or more resources occur within a phase. During such sub-phases, the platform quality of service manager 340 may detect changes in the performance of the application and vary the class of service within the range associated with the phase of the application to maintain the target performance metric.

The performance determiner 346, in the illustrative embodiment, is configured to determine one or more performance metrics of each application on a continual basis. For example, the performance determiner 346 may continually determine the number of instructions per cycle that have been executed by the core 230 associated with the application, the number of cache hits or cache misses in a predefined period of time, the latency in providing an output for a given set of operations, or other measures of the performance of each application executed by the compute device 130. In the illustrative embodiment, the performance determiner 346 may determine the performance metrics at intervals indicated in the class of service data 306.

The class of service adjuster 348, in the illustrative embodiment, is configured to selectively increase or decrease the class of service associated with one or more resources of the compute device 130 in response to a determination of whether a performance metric associated with each application satisfies the corresponding target performance metric for the present phase of each application. If the target performance metric is satisfied, the class of service adjuster 348 may reduce the present class of service for one or more resources allocated to an application to a lower class of service (e.g., fewer ways of cache associativity, less memory bandwidth, etc.) within the range of classes of service for the present phase of the application. As a result, the class of service adjuster 348 may free up resources for use by other applications. By contrast, in response to a determination that the target performance metric is not presently met by an application, the class of service adjuster 348 may increase the class of service to a higher class of service within the range specified for the present phase of the application, to provide more resources to the application and thereby increase the performance of the application. In selectively adjusting the classes of service, the class of service adjuster 348 may identify a particular type of resource for which to increase the class of service (e.g., more ways of cache associativity) as a function of the type of target performance metric that was not satisfied (e.g., cache hits), or may increase the class of service for all resources for which higher classes of service are present in the class of service data 306. Moreover, the class of service adjuster 348 may adjust the class of service at a rate (e.g., linear increments, exponential increments, etc.) specified in the class of service data.

It should be appreciated that each of the phase determiner 342, the sub-phase determiner 344, the performance determiner 346, and the class of service adjuster 348 may be separately embodied as hardware, firmware, software, virtualized hardware, emulated architecture, and/or a combination thereof. For example, the phase determiner 342 may be embodied as a hardware component, while each of the sub-phase determiner 344, the performance determiner 346, and/or the class of service adjuster 348 is embodied as a virtualized hardware component or as some other combination of hardware, firmware, software, virtualized hardware, emulated architecture, and/or a combination thereof.

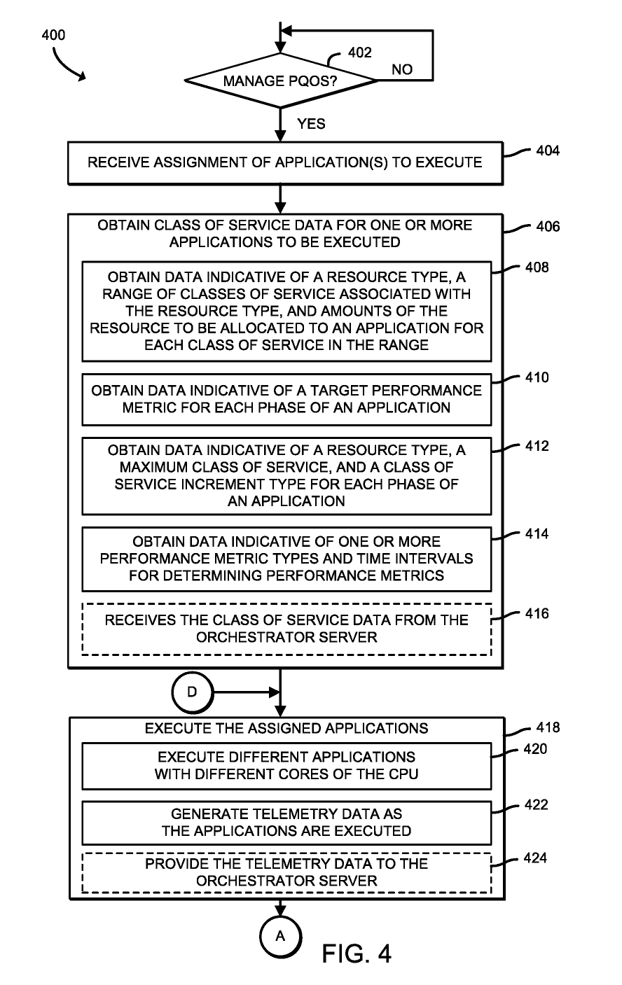

Referring now to FIG. 4, in use, each compute device 130 may execute a method 400 for adaptively controlling a platform quality of service. The method 400 begins with block 402, in which the compute device 130, in the illustrative embodiment, determines whether to manage the platform quality of service of the compute device 130. In doing so, in the illustrative embodiment, the compute device 130 may determine whether the CPU 202 includes the pQoS adaptive logic unit 220, such as by checking a register of the CPU 202 for a predefined value indicative of the presence of the pQoS adaptive logic unit 220. In other embodiments, the compute device 130 may determine whether to manage the platform quality of service based on other factors. Regardless, in response to a determination to manage the platform quality of service, the method 400 advances to block 404 in which the compute device 130 receives an assignment of one or more applications to execute. In doing so, the compute device 130 may receive identifiers of the applications and/or the application code itself from the orchestrator server 140. In other embodiments, the compute device 130 may receive the assignment of the one or more applications from another source, such as a user interacting with the compute device 130 directly (e.g., through a user interface), from another compute device 130, or from another source. Regardless, after receiving the assignment of the one or more applications to execute, the method 400 advances to block 406 in which the compute device 130 obtains class of service data (e.g., the class of service data 306) for the one or more applications to be executed. In other embodiments, the compute device 130 may obtain the class of service data 306 prior to receiving the assignments. In yet other embodiments, the compute device 130 may receive the class of service data 306 concurrently with receipt of the assignment of the applications to execute (e.g., as metadata associated with the applications, as parameters to one or more assignment requests, etc.).

In obtaining the class of service data 306, the compute device 130 obtains data indicative of a resource type (e.g., number of ways of cache associativity, memory bandwidth, etc.), a range of classes of service associated with the resource type, and amounts of each resource to be allocated to an application for each class of service in the range, as indicated in block 408. For example, the range of classes of service for cache may include a first class of service indicative of 10 ways of cache associativity, a second class of service indicative of 12 ways of cache associativity, a third class of service indicative of 14 ways of cache associativity, and so on. Similarly, the range of classes of service for memory bandwidth may include a first class of service indicative of 10% of the memory bandwidth, a second class of service indicative of 20% of the memory bandwidth, a third class of service indicative of 30% of the memory bandwidth, and so on. Additionally, in block 410, in obtaining the class of service data 306, the compute device 130 obtains data indicative of a target performance metric for each phase of an application. In the illustrative embodiment, the data may indicate a target performance metric of 10 instructions per cycle in phase A of an application, which may be associated with a relatively high processor utilization and a relatively low memory utilization. The data may also indicate a target performance metric of 6 instructions per cycle in phase B of the application, which may be associated with a relatively low processor utilization and a high memory utilization. The compute device 130 may receive multiple target performance metrics for each phase (e.g., a target number of instructions per cycle and a target number of cache misses). As indicated in block 412, the compute device 130, in the illustrative embodiment, also obtains data indicative of, for each resource type (e.g., number of ways of cache associativity, memory bandwidth, etc.) a maximum class of service that may be set, and a class of service increment type for each phase of each application. Using the example above, the compute device 130 may obtain data that indicates that for phase A of the application, the maximum class of service that can be set is the third class of service for each resource type, and for phase B of the application, the class of service for the memory bandwidth may reach the third class of service, but the class of service for the number of ways of cache associativity may only reach the second class of service. The increment types are indicative of how quickly the class of service for one or more resource types are to be incremented in response to a determination that the performance of the application is not satisfying a corresponding target performance metric for the present phase of the application. As such, the increment type may be linear, exponential, or another rate at which to increment the class of service.

In block 414, in the illustrative embodiment, the compute device 130 obtains data indicative of one or more performance metric types and time intervals for periodically determining the corresponding performance metrics of the one or more applications as they are executed. For example, the data may indicate that the number of instructions per second should be determined approximately every 2 to 3 microseconds and the number of cache misses should be determined approximately every 1 to 2 microseconds. As indicated in block 416, in the illustrative embodiment, the compute device 130 receives the class of service data 306 from the orchestrator server 140, as discussed above. In other embodiments, the compute device 130 may obtain the class of service data 306 from another source (e.g., input directly by an administrator through a user interface, read from a configuration file which may have been previously written by the compute device 130 based on previous executions of the applications, etc.). Subsequently, the method 400 advances to block 418, in which the compute device 130 executes the assigned one or more applications.

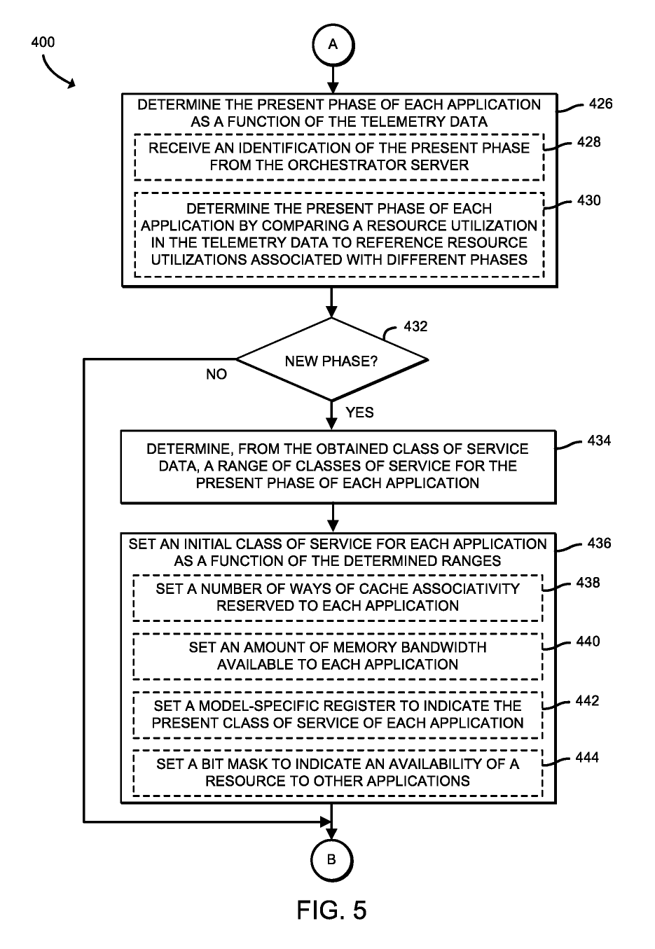

In executing the applications, the compute device 130 may execute different applications with different cores 230 of the CPU 202 (e.g., one application per core), as indicated in block 420. Additionally, in the illustrative embodiment, the compute device 130 generates the telemetry data 302 as the one or more applications are executed, as indicated in block 422. Further, in the illustrative embodiment, the compute device 130 may provide (e.g., send) the telemetry data 302 to the orchestrator server 140 for analysis (e.g., determination of the present phase of each application), as indicated in block 424. Subsequently, the method 400 advances to block 426 of FIG. 5, in which the compute device 130 determines the present phase of each application as a function of the telemetry data 302.

Referring now to FIG. 5, in determining the present phase of each application, the compute device 130 may receive an identification of the present phase of each application from the orchestrator server 140, as indicated in block 428. Alternatively, and as indicated in block 430, the compute device 130 may determine the present phase of each application locally by comparing one or more resource utilizations (e.g., present processor utilization, present memory utilization, etc.) indicated in the telemetry data 302 to reference resource utilizations associated with different phases of each application (e.g., in the phase data 304). Subsequently, in block 432, the compute device 130 determines whether one or more of the applications has changed to a new phase. Initially, the result will be yes, as the present phase of each application is the first phase determined since execution began. In response to a determination that the present phase of the one or more applications is a new phase, the method 400 advances to block 434 in which the compute device determines, from the obtained class of service data 306, the range of classes of service for each resource for the present phase of each application (e.g., the ranges and maximum class of service data obtained in blocks 408 and 412 of FIG. 4).

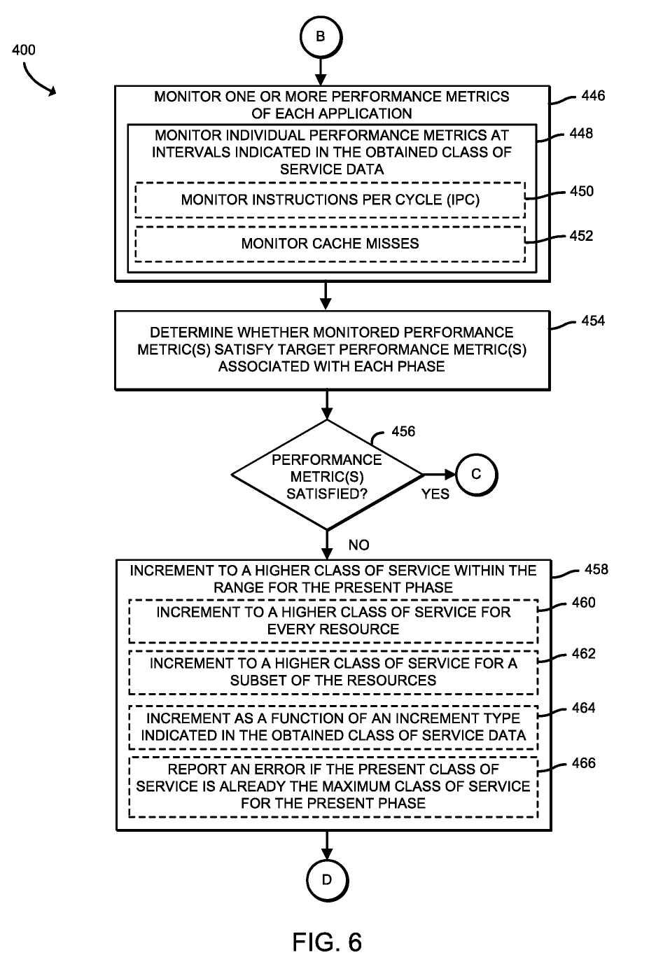

In block 436, the compute device 130 sets an initial class of service for each application as a function of the determined ranges. In doing so, the compute device 130 may set a number of ways of cache associativity reserved to each application, as indicated in block 438. As indicated in block 440, the compute device 130 may set an amount of memory bandwidth available to each application. Further, the compute device 130 may set a model-specific register (e.g., one or more of the registers 240) to indicate the present class of service for each application, as indicated in block 442. Additionally, as indicated in block 444, the compute device 130 may set a bit mask or other data to indicate the availability one or more of the resources to other applications executed by the compute device 130. Subsequently, or if a new phase was not detected in block 432, the method 400 advances to block 446 of FIG. 6, in which compute device 130 monitors one or more performance metrics of each application.

Referring now to FIG. 6, in monitoring the performance metrics, the compute device 130, in the illustrative embodiment, may monitor individual performance metrics at the intervals indicated in the obtained class of service data 306 (e.g., the intervals from block 414 of FIG. 4), as indicated in block 448. In doing so, the compute device may monitor the number of instructions per cycle for each application, as indicated in block 450. Additionally or alternatively, the compute device 130 may monitor the number of cache misses for each application, as indicated in block 452. In other embodiments, the compute device 130 may monitor other performance metrics.

Subsequently, in block 454, the compute device 130 determines whether the monitored performance metrics satisfy the corresponding target performance metrics associated with the present phase of each application. Afterwards, in block 456, the compute device 130 determines the subsequent course of action as a function of whether the target performance metrics were satisfied. If one or more of the target performance metrics were not satisfied, the method 400 advances to block 458. In block 458, the compute device 130 increments the present class of service for one or more resources to a higher class of service within the range associated with the present phase of each application for which the corresponding target performance metric was not satisfied. In doing so, and as indicated in block 460, the compute device 130 may increment to a higher class of service for every resource identified in the class of service data 306. Alternatively, the compute device 130 may increment the present class of service to a higher class of service for only a subset of the resources identified in the class of service data 306 (e.g., only incrementing the memory bandwidth without incrementing the ways of cache associativity), as indicated in block 462. In incrementing to a higher class of service, the compute device 130 may increment as a function of the increment type indicated in the class of service data 306 (e.g., a linear increment, an exponential increment, etc.), as indicated in block 464. Alternatively, the compute device 130 may report an error (e.g., to a user through a user interface, to the orchestrator server 140, etc.) if the present class of service is already the maximum class of service for the present phase, as indicated in block 466. Subsequently, the method 400 loops back to block 418 of FIG. 4, in which the compute device 130 continues to execute the assigned applications.

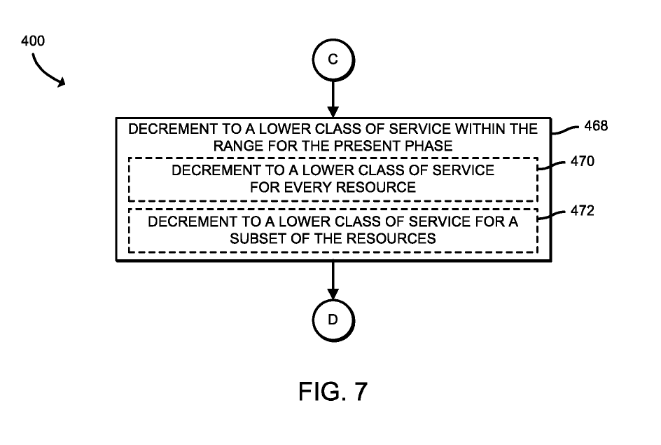

Referring back to block 456, if the compute device 130 instead determines that the target performance metrics for all of the applications have been met, the method 400 advances to block 468 of FIG. 7, in which the compute device 130 decrements the present class of service for the applications to a lower class of service within the range for the present phase of each application. Referring now to FIG. 7, in decrementing to a lower class of service, the compute device 130 may decrement to a lower class of service for every resource identified in the class of service data 306, as indicated in block 470. Alternatively, the compute device 130 may decrement to a lower class of service for only a subset of the resources (e.g., only decrement the class of service for the memory bandwidth while leaving the cache associativity class of service as is), as indicated in block 472. The method 400 subsequently loops back to block 418 of FIG. 4, in which the compute device 130 continues to execute the assigned applications. As such, the compute device 130 releases some amount of the resources for use by other applications and determines whether the target performance metrics are still satisfied.

### EXAMPLES

Illustrative examples of the technologies disclosed herein are provided below. An embodiment of the technologies may include any one or more, and any combination of, the examples described below.

Example 1 includes a compute device to adaptively control a platform quality of service, the compute device comprising one or more processors; one or more memory devices having stored therein a plurality of instructions that, when executed by the one or more processors, cause the compute device to obtain class of service data for an application to be executed, wherein the class of service data is indicative of an amount of one or more resources to be allocated to the application for each class of service in a range of classes of service, a target performance metric for each phase of the application, and a maximum class of service for each phase of the application; execute the application; determine, as a function of one or more resource utilizations of the application as the application is executed, a present phase of the application; set a present class of service for the application as a function of the determined phase, wherein the present class of service is within the range associated with the determined phase; determine whether a present performance metric of the application satisfies the target performance metric; and increment, in response to a determination that the present performance metric does not satisfy the target performance metric, the present class of service to a higher class of service in the range.

Example 2 includes the subject matter of Example 1, and wherein the plurality of instructions, when executed, further cause the compute device to decrement, in response to a determination that the present performance metric satisfies the target performance metric, the present class of service to a lower class of service in the range.

Example 3 includes the subject matter of any of Examples 1 and 2, and wherein the plurality of instructions, when executed, further cause the compute device to detect whether the application has transitioned a subsequent phase; determine, in response to a determination that the application has transitioned to a subsequent phase, a second range of classes of service associated with the subsequent phase; and set a subsequent class of service for the application as a function of the subsequent phase, wherein the subsequent class of service is in the second range.

Example 4 includes the subject matter of any of Examples 1-3, and wherein to obtain the class of service data comprises to receive increment type data indicative of an amount by which to increment the present class of service in response to a determination that the present performance metric does not satisfy the target performance metric.

Example 5 includes the subject matter of any of Examples 1-4, and wherein to increment the class of service comprises to increase a number of ways of cache associativity available to the application.

Example 6 includes the subject matter of any of Examples 1-5, and wherein to increment the class of service comprises to increase a memory bandwidth available to the application.

Example 7 includes the subject matter of any of Examples 1-6, and wherein the plurality of instructions, when executed, further cause the compute device set a model-specific register to indicate the present class of service of the application.

Example 8 includes the subject matter of any of Examples 1-7, and wherein the plurality of instructions, when executed, further cause the compute device to set a bit mask indicative of an availability of one or more resources to other applications.

Example 9 includes the subject matter of any of Examples 1-8, and wherein to determine whether the present performance metric satisfies the target performance metric comprises to determine whether a present number of instructions per cycle satisfies a target number of instructions per cycle.

Example 10 includes the subject matter of any of Examples 1-9, and wherein to determine whether the present performance metric satisfies the target performance metric comprises to determine whether a present number of cache misses satisfies a target number of cache misses.

Example 11 includes the subject matter of any of Examples 1-10, and wherein to increment the present class of service comprises to increase an amount of one resource allocated to the application.

Example 12 includes the subject matter of any of Examples 1-11, and wherein to increment the present class of service comprises to increase an amount of multiple resources allocated to the application.

Example 13 includes the subject matter of any of Examples 1-12, and wherein, the plurality of instructions, when executed, further cause the compute device to report telemetry data indicative of resource utilizations by the application to an orchestrator server; and to determine the present phase of the application comprises to receive an identification of the present phase from the orchestrator server.

Example 14 includes the subject matter of any of Examples 1-13, and wherein to determine the present phase of the application comprises to compare the resource utilization of the application to reference resource utilizations associated with different phases.

Example 15 includes the subject matter of any of Examples 1-14, and wherein the one or more processors include multiple cores, and wherein to execute the application comprises to execute multiple applications with different cores of the compute device.

Example 16 includes a method for adaptively controlling a platform quality of service, the method comprising obtaining, by a compute device, class of service data for an application to be executed, wherein the class of service data is indicative of an amount of one or more resources to be allocated to the application for each class of service in a range of classes of service, a target performance metric for each phase of the application, and a maximum class of service for each phase of the application; executing, by the compute device, the application; determining, by the compute device and as a function of one or more resource utilizations of the application as the application is executed, a present phase of the application; setting, by the compute device, a present class of service for the application as a function of the determined phase, wherein the present class of service is within the range associated with the determined phase; determining, by the compute device, whether a present performance metric of the application satisfies the target performance metric; and incrementing, by the compute device and in response to a determination that the present performance metric does not satisfy the target performance metric, the present class of service to a higher class of service in the range.

Example 17 includes the subject matter of Example 16, and further including decrementing, by the compute device and in response to a determination that the present performance metric satisfies the target performance metric, the present class of service to a lower class of service in the range.

Example 18 includes the subject matter of any of Examples 16 and 17, and further including detecting, by the compute device, whether the application has transitioned a subsequent phase; determining, by the compute device and in response to a determination that the application has transitioned to a subsequent phase, a second range of classes of service associated with the subsequent phase; and setting, by the compute device, a subsequent class of service for the application as a function of the subsequent phase, wherein the subsequent class of service is in the second range.

Example 19 includes the subject matter of any of Examples 16-18, and wherein obtaining the class of service data comprises receiving increment type data indicative of an amount by which to increment the present class of service in response to a determination that the present performance metric does not satisfy the target performance metric.

Example 20 includes the subject matter of any of Examples 16-19, and wherein incrementing the class of service comprises increasing a number of ways of cache associativity available to the application.

Example 21 includes the subject matter of any of Examples 16-20, and wherein incrementing the class of service comprises increasing a memory bandwidth available to the application.

Example 22 includes the subject matter of any of Examples 16-21, and further including setting, by the compute device, a model-specific register to indicate the present class of service of the application.

Example 23 includes the subject matter of any of Examples 16-22, and further including setting, by the compute device, a bit mask indicative of an availability of one or more resources to other applications.

Example 24 includes the subject matter of any of Examples 16-23, and wherein determining whether the present performance metric satisfies the target performance metric comprises determining whether a present number of instructions per cycle satisfies a target number of instructions per cycle.

Example 25 includes the subject matter of any of Examples 16-24, and wherein determining whether the present performance metric satisfies the target performance metric comprises determining whether a present number of cache misses satisfies a target number of cache misses.

Example 26 includes the subject matter of any of Examples 16-25, and wherein incrementing the present class of service comprises increasing an amount of one resource allocated to the application.

Example 27 includes the subject matter of any of Examples 16-26, and wherein incrementing the present class of service comprises increasing an amount of multiple resources allocated to the application.

Example 28 includes the subject matter of any of Examples 16-27, and further including reporting, by the compute device, telemetry data indicative of resource utilizations by the application to an orchestrator server; and wherein determining the present phase of the application comprises receiving an identification of the present phase from the orchestrator server.

Example 29 includes the subject matter of any of Examples 16-28, and wherein determining the present phase of the application comprises comparing the resource utilization of the application to reference resource utilizations associated with different phases.

Example 30 includes the subject matter of any of Examples 16-29, and wherein executing the application comprises executing multiple applications with different cores of the compute device.

Example 31 includes one or more machine-readable storage media comprising a plurality of instructions stored thereon that, in response to being executed, cause a compute device to perform the method of any of Examples 16-30.

Example 32 includes a compute device to adaptively control a platform quality of service, the compute device comprising one or more processors; one or more memory devices having stored therein a plurality of instructions that, when executed by the one or more processors, cause the compute device to perform the method of any of Examples 16-30.

Example 33 includes a compute device comprising means for performing the method of any of Examples 16-30.

Example 34 includes a compute device to adaptively control a platform quality of service, the compute device comprising platform quality of service manager circuitry to obtain class of service data for an application to be executed, wherein the class of service data is indicative of an amount of one or more resources to be allocated to the application for each class of service in a range of classes of service, a target performance metric for each phase of the application, and a maximum class of service for each phase of the application; and application executor circuitry to execute the application; wherein the platform quality of service manager circuitry is further to determine, as a function of one or more resource utilizations of the application as the application is executed, a present phase of the application, set a present class of service for the application as a function of the determined phase, wherein the present class of service is within the range associated with the determined phase, determine whether a present performance metric of the application satisfies the target performance metric, and increment, in response to a determination that the present performance metric does not satisfy the target performance metric, the present class of service to a higher class of service in the range.

Example 35 includes the subject matter of Example 34, and wherein the platform quality of service manager circuitry is further to decrement, in response to a determination that the present performance metric satisfies the target performance metric, the present class of service to a lower class of service in the range.

Example 36 includes the subject matter of any of Examples 34 and 35, and wherein the platform quality of service manager circuitry is further to detect whether the application has transitioned a subsequent phase; determine, in response to a determination that the application has transitioned to a subsequent phase, a second range of classes of service associated with the subsequent phase; and set a subsequent class of service for the application as a function of the subsequent phase, wherein the subsequent class of service is in the second range.

Example 37 includes the subject matter of any of Examples 34-36, and wherein to obtain the class of service data comprises to receive increment type data indicative of an amount by which to increment the present class of service in response to a determination that the present performance metric does not satisfy the target performance metric.

Example 38 includes the subject matter of any of Examples 34-37, and wherein to increment the class of service comprises to increase a number of ways of cache associativity available to the application.

Example 39 includes the subject matter of any of Examples 34-38, and wherein to increment the class of service comprises to increase a memory bandwidth available to the application.

Example 40 includes the subject matter of any of Examples 34-39, and wherein the platform quality of service manager circuitry is further to set a model-specific register to indicate the present class of service of the application.

Example 41 includes the subject matter of any of Examples 34-40, and wherein the platform quality of service manager circuitry is further to set a bit mask indicative of an availability of one or more resources to other applications.

Example 42 includes the subject matter of any of Examples 34-41, and wherein to determine whether the present performance metric satisfies the target performance metric comprises to determine whether a present number of instructions per cycle satisfies a target number of instructions per cycle.

Example 43 includes the subject matter of any of Examples 34-42, and wherein to determine whether the present performance metric satisfies the target performance metric comprises to determine whether a present number of cache misses satisfies a target number of cache misses.

Example 44 includes the subject matter of any of Examples 34-43, and wherein to increment the present class of service comprises to increase an amount of one resource allocated to the application.

Example 45 includes the subject matter of any of Examples 34-44, and wherein to increment the present class of service comprises to increase an amount of multiple resources allocated to the application.

Example 46 includes the subject matter of any of Examples 34-45, and further including network communicator circuitry to report telemetry data indicative of resource utilizations by the application to an orchestrator server; and wherein to determine the present phase of the application comprises to receive an identification of the present phase from the orchestrator server.

Example 47 includes the subject matter of any of Examples 34-46, and wherein to determine the present phase of the application comprises to compare the resource utilization of the application to reference resource utilizations associated with different phases.

Example 48 includes the subject matter of any of Examples 34-47, and wherein to execute the application comprises to execute multiple applications with different cores of the compute device.

Example 49 includes a compute device to adaptively control a platform quality of service, the compute device comprising circuitry for obtaining class of service data for an application to be executed, wherein the class of service data is indicative of an amount of one or more resources to be allocated to the application for each class of service in a range of classes of service, a target performance metric for each phase of the application, and a maximum class of service for each phase of the application; circuitry for executing the application; means for determining, a function of one or more resource utilizations of the application as the application is executed, a present phase of the application; means for setting a present class of service for the application as a function of the determined phase, wherein the present class of service is within the range associated with the determined phase; means for determining whether a present performance metric of the application satisfies the target performance metric; and means for incrementing, in response to a determination that the present performance metric does not satisfy the target performance metric, the present class of service to a higher class of service in the range.

Example 50 includes the subject matter of Example 49, and further including means for decrementing, in response to a determination that the present performance metric satisfies the target performance metric, the present class of service to a lower class of service in the range.

Example 51 includes the subject matter of any of Examples 49 and 50, and further including means for detecting whether the application has transitioned a subsequent phase; means for determining, in response to a determination that the application has transitioned to a subsequent phase, a second range of classes of service associated with the subsequent phase; and means for setting a subsequent class of service for the application as a function of the subsequent phase, wherein the subsequent class of service is in the second range.

Example 52 includes the subject matter of any of Examples 49-51, and wherein the circuitry for obtaining the class of service data comprises circuitry for receiving increment type data indicative of an amount by which to increment the present class of service in response to a determination that the present performance metric does not satisfy the target performance metric.

Example 53 includes the subject matter of any of Examples 49-52, and wherein the means for incrementing the class of service comprises circuitry for increasing a number of ways of cache associativity available to the application.

Example 54 includes the subject matter of any of Examples 49-53, and wherein means for incrementing the class of service comprises circuitry for increasing a memory bandwidth available to the application.

Example 55 includes the subject matter of any of Examples 49-54, and further including circuitry for setting a model-specific register to indicate the present class of service of the application.

Example 56 includes the subject matter of any of Examples 49-55, and further including circuitry for setting a bit mask indicative of an availability of one or more resources to other applications.

Example 57 includes the subject matter of any of Examples 49-56, and wherein the means for determining whether the present performance metric satisfies the target performance metric comprises circuitry for determining whether a present number of instructions per cycle satisfies a target number of instructions per cycle.

Example 58 includes the subject matter of any of Examples 49-57, and wherein the means for determining whether the present performance metric satisfies the target performance metric comprises circuitry for determining whether a present number of cache misses satisfies a target number of cache misses.

Example 59 includes the subject matter of any of Examples 49-58, and wherein the means for incrementing the present class of service comprises circuitry for increasing an amount of one resource allocated to the application.

Example 60 includes the subject matter of any of Examples 49-59, and wherein the means for incrementing the present class of service comprises circuitry for increasing an amount of multiple resources allocated to the application.

Example 61 includes the subject matter of any of Examples 49-60, and further including circuitry for reporting telemetry data indicative of resource utilizations by the application to an orchestrator server; and wherein the means for determining the present phase of the application comprises circuitry for receiving an identification of the present phase from the orchestrator server.

Example 62 includes the subject matter of any of Examples 49-61, and wherein the means for determining the present phase of the application comprises circuitry for comparing the resource utilization of the application to reference resource utilizations associated with different phases.

Example 63 includes the subject matter of any of Examples 49-62, and wherein the circuitry for executing the application comprises circuitry for executing multiple applications with different cores of the compute device.

1. A compute device to adaptively control a platform quality of service, the compute device comprising:
one or more processors;
one or more memory devices having stored therein a plurality of instructions that, when executed by the one or more processors, cause the compute device to:
obtain class of service data for an application to be executed, wherein the class of service data is indicative of an amount of one or more resources to be allocated to the application for each class of service in a range of classes of service, a target performance metric for each phase of the application, and a maximum class of service for each phase of the application;
execute the application;
determine, as a function of one or more resource utilizations of the application as the application is executed, a present phase of the application;
set a present class of service for the application as a function of the determined phase, wherein the present class of service is within the range associated with the determined phase;
determine whether a present performance metric of the application satisfies the target performance metric; and
increment, in response to a determination that the present performance metric does not satisfy the target performance metric, the present class of service to a higher class of service in the range.

2. The compute device of claim 1, wherein the plurality of instructions, when executed, further cause the compute device to decrement, in response to a determination that the present performance metric satisfies the target performance metric, the present class of service to a lower class of service in the range.

3. The compute device of claim 1, wherein the plurality of instructions, when executed, further cause the compute device to:
detect whether the application has transitioned a subsequent phase;
determine, in response to a determination that the application has transitioned to a subsequent phase, a second range of classes of service associated with the subsequent phase; and
set a subsequent class of service for the application as a function of the subsequent phase, wherein the subsequent class of service is in the second range.

4. The compute device of claim 1, wherein to obtain the class of service data comprises to receive increment type data indicative of an amount by which to increment the present class of service in response to a determination that the present performance metric does not satisfy the target performance metric.

5. The compute device of claim 1, wherein to increment the class of service comprises to increase a number of ways of cache associativity available to the application.

6. The compute device of claim 1, wherein to increment the class of service comprises to increase a memory bandwidth available to the application.

7. The compute device of claim 1, wherein the plurality of instructions, when executed, further cause the compute device set a model-specific register to indicate the present class of service of the application.

8. The compute device of claim 1, wherein the plurality of instructions, when executed, further cause the compute device to set a bit mask indicative of an availability of one or more resources to other applications.

9. The compute device of claim 1, wherein to determine whether the present performance metric satisfies the target performance metric comprises to determine whether a present number of instructions per cycle satisfies a target number of instructions per cycle.

10. The compute device of claim 1, wherein to determine whether the present performance metric satisfies the target performance metric comprises to determine whether a present number of cache misses satisfies a target number of cache misses.

11. The compute device of claim 1, wherein to increment the present class of service comprises to increase an amount of one resource allocated to the application.

12. The compute device of claim 1, wherein to increment the present class of service comprises to increase an amount of multiple resources allocated to the application.

13. One or more machine-readable storage media comprising a plurality of instructions stored thereon that, in response to being executed, cause a compute device to:
obtain class of service data for an application to be executed, wherein the class of service data is indicative of an amount of one or more resources to be allocated to the application for each class of service in a range of classes of service, a target performance metric for each phase of the application, and a maximum class of service for each phase of the application;
execute the application;
determine, as a function of one or more resource utilizations of the application as the application is executed, a present phase of the application;
set a present class of service for the application as a function of the determined phase, wherein the present class of service is within the range associated with the determined phase;
determine whether a present performance metric of the application satisfies the target performance metric; and
increment, in response to a determination that the present performance metric does not satisfy the target performance metric, the present class of service to a higher class of service in the range.

14. The one or more machine-readable storage media of claim 13, wherein the plurality of instructions, when executed, further cause the compute device to decrement, in response to a determination that the present performance metric satisfies the target performance metric, the present class of service to a lower class of service in the range.

15. The one or more machine-readable storage media of claim 13, wherein the plurality of instructions, when executed, further cause the compute device to:
detect whether the application has transitioned a subsequent phase;
determine, in response to a determination that the application has transitioned to a subsequent phase, a second range of classes of service associated with the subsequent phase; and
set a subsequent class of service for the application as a function of the subsequent phase, wherein the subsequent class of service is in the second range.

16. The one or more machine-readable storage media of claim 13, wherein to obtain the class of service data comprises to receive increment type data indicative of an amount by which to increment the present class of service in response to a determination that the present performance metric does not satisfy the target performance metric.

17. The one or more machine-readable storage media of claim 13, wherein to increment the class of service comprises to increase a number of ways of cache associativity available to the application.

18. The one or more machine-readable storage media of claim 13, wherein to increment the class of service comprises to increase a memory bandwidth available to the application.

19. The one or more machine-readable storage media of claim 13, wherein the plurality of instructions, when executed, further cause the compute device set a model-specific register to indicate the present class of service of the application.

20. The one or more machine-readable storage media of claim 13, wherein the plurality of instructions, when executed, further cause the compute device to set a bit mask indicative of an availability of one or more resources to other applications.

21. The one or more machine-readable storage media of claim 13, wherein to determine whether the present performance metric satisfies the target performance metric comprises to determine whether a present number of instructions per cycle satisfies a target number of instructions per cycle.

22. The one or more machine-readable storage media of claim 13, wherein to determine whether the present performance metric satisfies the target performance metric comprises to determine whether a present number of cache misses satisfies a target number of cache misses.

23. The one or more machine-readable storage media of claim 13, wherein to increment the present class of service comprises to increase an amount of one resource allocated to the application.

24. The one or more machine-readable storage media of claim 13, wherein to increment the present class of service comprises to increase an amount of multiple resources allocated to the application.

25. A compute device to adaptively control a platform quality of service, the compute device comprising:
circuitry for obtaining class of service data for an application to be executed, wherein the class of service data is indicative of an amount of one or more resources to be allocated to the application for each class of service in a range of classes of service, a target performance metric for each phase of the application, and a maximum class of service for each phase of the application;
circuitry for executing the application;
means for determining, as a function of one or more resource utilizations of the application as the application is executed, a present phase of the application;
means for setting a present class of service for the application as a function of the determined phase, wherein the present class of service is within the range associated with the determined phase;
means for determining whether a present performance metric of the application satisfies the target performance metric; and
means for incrementing, in response to a determination that the present performance metric does not satisfy the target performance metric, the present class of service to a higher class of service in the range.

26. A method for adaptively controlling a platform quality of service, the method comprising:
obtaining, by a compute device, class of service data for an application to be executed, wherein the class of service data is indicative of an amount of one or more resources to be allocated to the application for each class of service in a range of classes of service, a target performance metric for each phase of the application, and a maximum class of service for each phase of the application;
executing, by the compute device, the application;
determining, by the compute device and as a function of one or more resource utilizations of the application as the application is executed, a present phase of the application;
setting, by the compute device, a present class of service for the application as a function of the determined phase, wherein the present class of service is within the range associated with the determined phase;
determining, by the compute device, whether a present performance metric of the application satisfies the target performance metric; and
incrementing, by the compute device and in response to a determination that the present performance metric does not satisfy the target performance metric, the present class of service to a higher class of service in the range.

27. The method of claim 26, further comprising decrementing, by the compute device and in response to a determination that the present performance metric satisfies the target performance metric, the present class of service to a lower class of service in the range.

28. The method of claim 26, further comprising:
detecting, by the compute device, whether the application has transitioned to a subsequent phase;
determining, by the compute device and in response to a determination that the application has transitioned to a subsequent phase, a second range of classes of service associated with the subsequent phase; and
setting, by the compute device, a subsequent class of service for the application as a function of the subsequent phase, wherein the subsequent class of service is in the second range.
